(19) United States
(12) Patent Application Publication
(10) Pub. No.: US 2004/0175175 A1
(43) Pub. Date: Sep. 9, 2004

(54) Optical packet router for an optical node in a packet switched WDM optical network

(76) Inventors: Neophytos A. Antoniades, Leonia, NJ (US); Valeria L. da Silva, Corning, NY (US); June-Koo Rhee, Morganville, NJ (US)

Correspondence Address: CORNING INCORPORATED, SP-TI-3-1, CORNING, NY, 14831

(21) Appl. No.: 10/378,392

(22) Filed: Mar. 3, 2003

(51) Int. Cl. H04J 14/00

(52) U.S. Cl. 398/51; 398/154

(57) ABSTRACT

The present invention is directed to an optical router device that is configured to route optical packets in a TDM/WDM optical network. The optical device is disposed in a node of the WDM optical network. The WDM optical network is configured to accommodate a plurality of wavelength channels. Each of the plurality of wavelength channels is configured to propagate optical packets in a time division multiplexed (TDM) arrangement. Each optical packet includes a baseband-payload and a subcarrier modulated (SCM) header. The device includes an optical WDM demultiplexer configured to demultiplex the plurality of wavelength channels. A header recovery component is coupled to the optical WDM demultiplexer. The header recovery element is configured to recover the SCM header in each optical packet propagating on each demultiplexed wavelength channel. A routing control processor (RCP) is coupled to the header recovery component. The RCP is configured to analyze the SCM header to determine which optical packets are destined for the node.

### BACKGROUND OF THE INVENTION

1. Field of the Invention

The present invention relates generally to WDM optical networks, and particularly to optical packet switched WDM networks.

2. Technical Background

For the last century or so, most telephony services have been provided by circuit switched networks. However, as the demand for bandwidth increases, network service providers have concluded that circuit switched telephony is relatively inefficient. In the past decade, new telecommunications technologies have emerged that employ packet switching instead of the traditional circuit switched technologies. When compared to circuit switching, packet switching promises to yield enormous benefits due to reductions in data exchange capacity required to support telephony traffic.

Over the same time period, fiber optic technology has also transformed the telecommunications industry. Early on, network designs included relatively low-speed transceiver electronics at each end of point-to-point communications links. Since then, systems have become far more sophisticated and complex. However, most of these systems still employ an electronic switching layer. It is now becoming apparent that electronic switching is a limiting factor with respect to network throughput. Network designers are seeking to migrate switching and routing functionality from the electrical domain into the optical domain.

In one approach, network designers are considering an optical packet switching network that supports internet-protocol related functionality such as label swapping, packet routing, and packet forwarding. The network under consideration includes a plurality of optical routers coupled to an N×N WDM arrayed waveguide grating (AWG) disposed at the hub of a star network. The AWG provides passive wavelength routing between nodes. Each router is coupled to the AWG by an optical transport layer. Each router converts incoming wavelength channels into one internal wavelength channel. This approach has some drawbacks. Because each router performs wavelength conversion on incoming wavelength channels, router throughput is limited to time-division multiplexing (TDM) optical packets received from all of the incoming wavelength channels. This also means that in order to achieve full connectivity between all nodes in the network, wavelength conversion is required.

What is needed is an optical packet switching network that takes advantage of both TDM and DWDM optical technologies.

### SUMMARY OF THE INVENTION

The present invention addresses the needs described above. The present invention is directed to a system and method for routing optical packets in a TDM/WDM optical network. Thus, the present invention includes an optical router that advantageously utilizes both time-division multiplexing and DWDM optical technologies in an optical packet switched network.

One aspect of the present invention is directed to an optical router device for routing optical packets in a TDM/WDM optical network. The optical device is disposed in a node of the WDM optical network. The WDM optical network is configured to accommodate a plurality of wavelength channels. Each of the plurality of wavelength channels is configured to propagate optical packets in a time division multiplexed (TDM) arrangement. Each optical packet includes a baseband-payload and a subcarrier modulated (SCM) header. The device includes an optical WDM demultiplexer configured to demultiplex the plurality of wavelength channels. At least one header recovery component is coupled to the optical WDM demultiplexer. The at least one header recovery element is configured to recover the SCM header in each optical packet propagating on each demultiplexed wavelength channel. A routing control processor (RCP) is coupled to the at least one header recovery component. The RCP is configured to analyze the SCM header to determine which optical packets are destined for the node.

In another aspect, the present invention is directed to a method for optical packet switching in a TDM/WDM optical network. The TDM/WDM optical network includes a plurality of nodes. The TDM/WDM optical network is configured to accommodate a plurality of wavelength channels. Each of the plurality of wavelength channels is configured to propagate optical packets in a time division multiplexed (TDM) arrangement. The method includes transmitting at least one optical packet over a predetermined wavelength channel in the WDM optical network. The at least one optical packet includes a baseband-payload and a subcarrier modulated (SCM) header. The predetermined wavelength channel is demultiplexed from the plurality of wavelength channels at a node in the WDM optical network. The SCM header is detected in the at least one optical packet propagating over the predetermined wavelength channel. The SCM header is analyzed to determine whether the at least one optical packet is destined for the node The baseband-payload is acquired if it is determined that the at least one optical packet is destined for the node.

In yet another aspect, the present invention is directed to an optical network for routing optical packets. The optical network is configured to accommodate a plurality of wavelength channels. Each of the plurality of wavelength channels accommodates optical packets in a time division multiplexed (TDM) arrangement. Each optical packet includes a baseband-payload and a subcarrier modulated (SCM) header. The network includes a plurality of nodes. An optical transport layer interconnects the plurality of nodes. An optical router is disposed at each of the plurality of nodes. The optical router includes an optical WDM demultiplexer configured to demultiplex the plurality of wavelength channels. At least one header recovery component is coupled to the optical WDM demultiplexer. The at least one header recovery element is configured to recover the SCM header in each optical packet propagating on each demultiplexed wavelength channel. A routing control processor (RCP) is coupled to the at least one header recovery component. The RCP is configured to analyze the SCM header to determine which optical packets are destined for the node.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a diagrammatic depiction of the TDM/WDM network in accordance with one embodiment of the present invention;

FIG. 2 is a functional block diagram of the optical network interface router depicted in FIG. 1;

FIG. 3 is a detail view of the optical network interface router in accordance with an embodiment of the present invention;

FIG. 4 is a detail view of the optical network interface router in accordance with a second embodiment of the present invention;

FIG. 5 is a detail view of the optical network interface router in accordance with a third embodiment of the present invention; and

FIG. 6 is a detail view of the optical network interface router in accordance with a fourth embodiment of the present invention.

### DETAILED DESCRIPTION

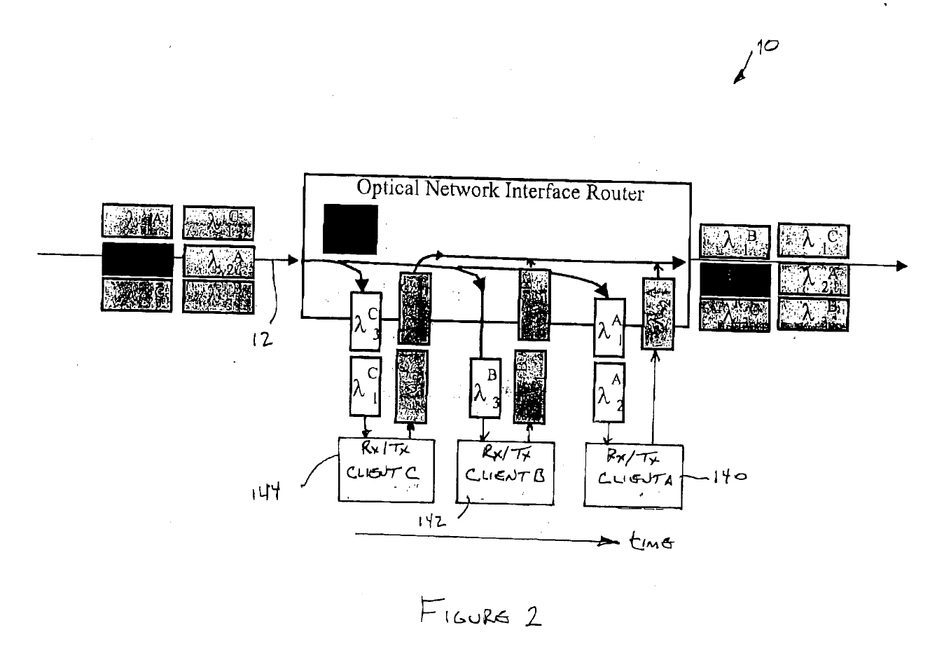

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the optical router of the present invention is shown in FIG. 2, and is designated generally throughout by reference numeral 10.

In accordance with the invention, the present invention is directed to an optical router device for routing optical packets in a TDM/WDM optical network. The optical device is disposed in a node of the WDM optical network. The WDM optical network is configured to accommodate a plurality of wavelength channels. Each of the plurality of wavelength channels is configured to propagate optical packets in a time division multiplexed (TDM) arrangement. Each optical packet includes a baseband-payload and a subcarrier modulated (SCM) header. The device includes an optical WDM demultiplexer configured to demultiplex the plurality of wavelength channels. At least one header recovery component is coupled to the optical WDM demultiplexer. The at least one header recovery element is configured to recover the SCM header in each optical packet propagating on each demultiplexed wavelength channel. A routing control processor (RCP) is coupled to the at least one header recovery component. The RCP is configured to analyze the SCM header to determine whether the optical packet is destined for the node. Thus, the present invention is directed to a system and method that advantageously utilizes both time-division multiplexing and DWDM optical technologies to route optical packets in a TDM/WDM optical network.

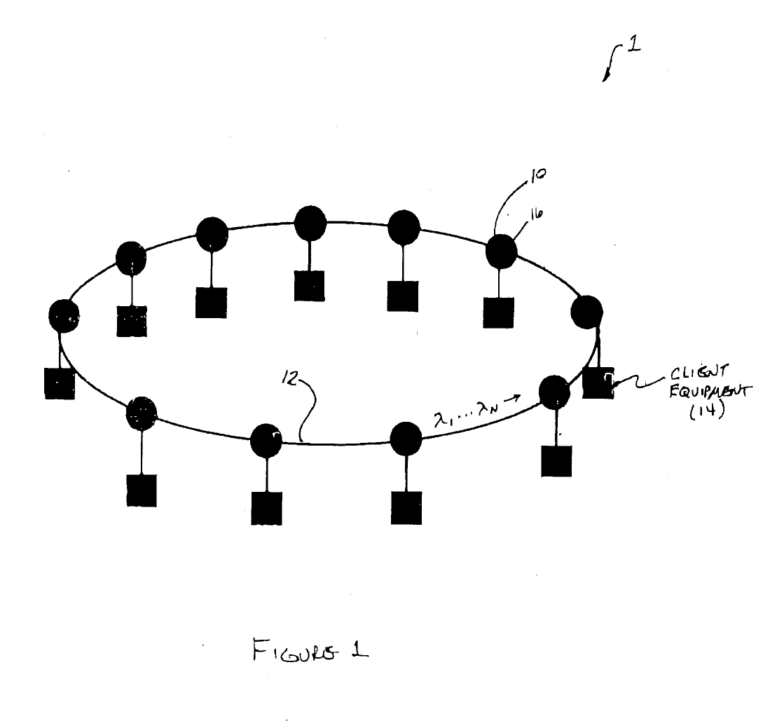

As embodied herein, and depicted in FIG. 1, a diagrammatic depiction of TDM/WDM ring network 1 in accordance with one embodiment of the present invention is disclosed. Ring network 1 includes a plurality of optical network interface routers 10 disposed at each node 16 in network 1. Routers 10 are interconnected by optical fiber transport layer 12. Although a node may be configured as a pass-through node, each router 10 is typically coupled to at least one client equipment 14. Client equipment 14 gains optical access to transport layer 12 via optical router 10. In one embodiment, network 1 supports up to 100 nodes and up to 2048 individual network addresses. In this embodiment, network 1 is also configured as a 100-Gbps DWDM system, accommodating 40-2.5 Gbps wavelength channels (8₁-8₄₀). In an alternate embodiment, network 1 is a 100-Gbps DWDM system accommodating 10-10 Gbps wavelength channels (8₁-8₁₀). In yet another embodiment, network 1 is a 200-Gbps DWDM system accommodating 80-2.5 Gbps wavelength channels (8₁-8₈₀).

Each optical packet includes a subcarrier modulated header and a baseband payload. The header contains routing and control information used by the optical routers to make routing decisions. The payload is, obviously, the client information that is transported by network 1. The payload is transmitted as a baseband signal over the optical wavelength channel. Header information is encoded on a subcarrier signal modulated over the same wavelength channel. A description of a transmitter in accordance with one embodiment of the invention is provided below.

Referring to FIG. 2, a functional block diagram of the optical network interface router 10 depicted in FIG. 1 is shown. By way of example, router 10 is bidirectionally coupled to client A, client B, and client C. Router 10 is shown processing TDM packets propagating on wavelength channel 81, wavelength channel 82, and wavelength channel 83. Wavelength channel 81 is shown as propagating a packet addressed to client A and a packet addressed to client C. Wavelength channel 82 is shown as propagating a packet addressed to client A and another packet not addressed to any of the clients coupled to router 10. Wavelength channel 83 is shown as propagating a packet addressed to client C and a packet addressed to client B. As shown, router 10 demultiplexes packets from both a TDM and WDM standpoint. For example, router 10 directs a client A wavelength channel 81 packet and a client A wavelength channel 82 packet into client A equipment 140 in the order in which the packets are received. On the transmit side, a wavelength channel 82 packet is received from client A equipment 140, and that packet is TDM/WDM multiplexed onto transport layer 12. As shown in FIG. 2, router 10 performs the same functions with respect to client B equipment 142 and client C equipment 144. It is noted that packets not addressed to any of clients at the node(e.g., see wavelength channel 82) are directed through the node by router 10.

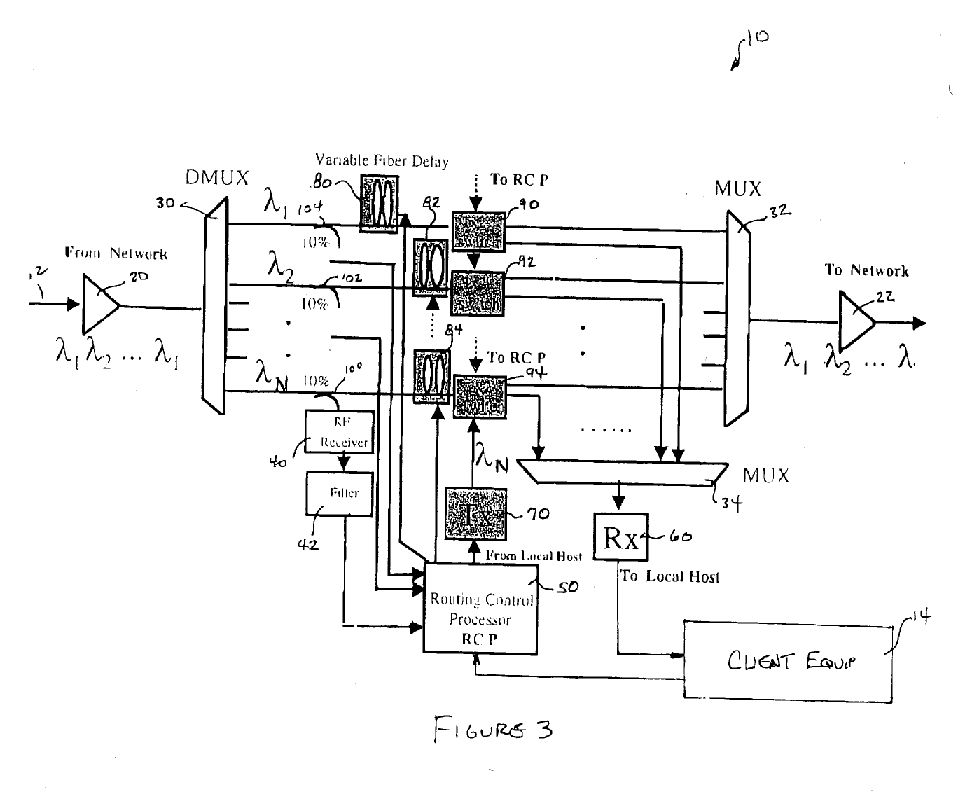

As embodied herein, and depicted in FIG. 3, a detail view of optical network interface router 10 in accordance with one embodiment of the present invention is disclosed. The router 10 depicted in FIG. 3 represents a tunable receiver/fixed transmitter approach.

On the receive side of optical router 10, incoming fiber 12 is coupled to fiber amplifier 20. Fiber amplifier 20 is coupled to demultiplexer 30. Demultiplexer 30 demultiplexes the DWDM optical signal into its constituent wavelength channels. Each output of demultiplexer 30 is coupled to a 1×2 splitter(100, 102, . . . , 104). As shown, wavelength channel 81 is directed into 1×2 splitter 104, wavelength channel 82 is directed into 1×2 splitter 102, and wavelength channel 8N is directed into 1×2 splitter 104. Splitters 100, 102, and 104 are coupled to variable fiber delays 84, 82, and 80, respectively. Each 1×2 splitter directs 90% of the incoming wavelength channel to a corresponding variable fiber delay component. Each variable fiber delay component (80, 82, . . . 84) is coupled to a corresponding optical switch (90, 92, . . . 94). One output of each switch is coupled to output multiplexer 32. The other output is coupled to receiver multiplexer 34. Output multiplexer 32 is coupled to output amplifier 22. Receiver multiplexer 34 is coupled to payload receiver 60.

Referring back to the 1×2 couplers (100, 102, . . . , 104), 10% of each wavelength channel is directed into an RF packet detection receiver 40. Each receiver 40 is coupled to a band-pass filter (BPF)42. The pass-band of the BPF 42 substantially corresponds to the bandwidth of the subcarrier multiplexed (SCM) packet header. Each BPF 42 is coupled to routing control processor (RCP) 50. For clarity of illustration, FIG. 3 shows only one RF packet detection receiver 40 and one BPF 42. However, those of ordinary skill in the art will recognize that each wavelength channel is coupled to a dedicated RF packet detection receiver 40 and BPF 42.

Referring back to the optical switches (90, 92, . . . , 94), the actuation of each optical switch is controlled by RCP 50. RCP 50 directs each switch (90, 92, . . . 94) to either direct the packet into receiver 60, or to direct the packet into transport layer 12, via demultiplexer 32, depending on the contents of SCM header. Packets directed to receiver 60 are dropped to the client, by way of client equipment 14.

Turning now to the transmit side of optical router 10, RCP 50 is coupled to fixed transmitter 70. Transmitter 70 is coupled to 2×2 switch 94. In the example of FIG. 3, input wavelength channel 8N and transmitter wavelength channel 8N are the inputs of 2×2 switch 94. One output of switch 94 is coupled to output multiplexer 32, and the other output is coupled to receiver multiplexer 34. Thus, at the discretion of RCP 50, transmission wavelength channel 8N may be directed onto transport layer 12 of network 1, or looped back to receiver 60.

Multiplexers 32 and 34, and demultiplexer 30 may be of any suitable type, but there is shown by way of example diffraction grating systems. Those of ordinary skill in the art will recognize that prism systems may also be employed. In one embodiment, amplifier 20 and amplifier 22 are implemented using erbium doped fiber amplifiers (EDFAs). RF receivers 40 may be implemented using photodiodes. As discussed above, RCP 50 must read the SCM headers acquired by RF receiver 40 within the time period provided by the variable fiber delays. Thus, RCP 50 may be of any suitable type, but by way of example, RCP may be implemented using high speed programmable logic gate array devices. Receiver 60 is a burst-mode receiver configured to acquire baseband payload signals.

Transmitter 70 may be implemented using a DFB laser coupled to the input of a differential Mach-Zehnder Modulator. The output of the DFB laser is modulated by coupling the baseband payload signal to one arm of the differential Mach-Zehnder Modulator. The output of the DFB laser is also simultaneously modulated by coupling the subcarrier modulated header signal to the other arm of the differential Mach-Zehnder Modulator.

Router 10 operates as follows. All wavelength channels are demultiplexed by demultiplexer 30 to yield a bursty TDM stream of incoming packets propagating on each individual wavelength. For each of the above described packets, the SCM header information is acquired using RF receiver 40 and BPF 42. RCP 50 reads the header and determines whether the incoming packet is destined for that node. Packet contention, where more than one packet is simultaneously destined for the same node, is handled by disposing the variable fiber delays (80, 82, . . . , 84) and multiplexer 34 before receiver 60. The variable fiber delays are controlled by RCP 50 and are configured to account for packet header processing time. If the packet is destined for the node, the optical switch (90, 92, . . . , 94) is actuated to direct the packet into multiplexer 34, and ultimately into receiver 34. Fixed wavelength transmitter 70 is used to insert optical packets in network 1 at transmission times determined by RCP 50. Since RCP 50 processes all of the optical packets input to router 10, transmitted packets are time division multiplexed into the output wavelength channel to avoid packet contention.

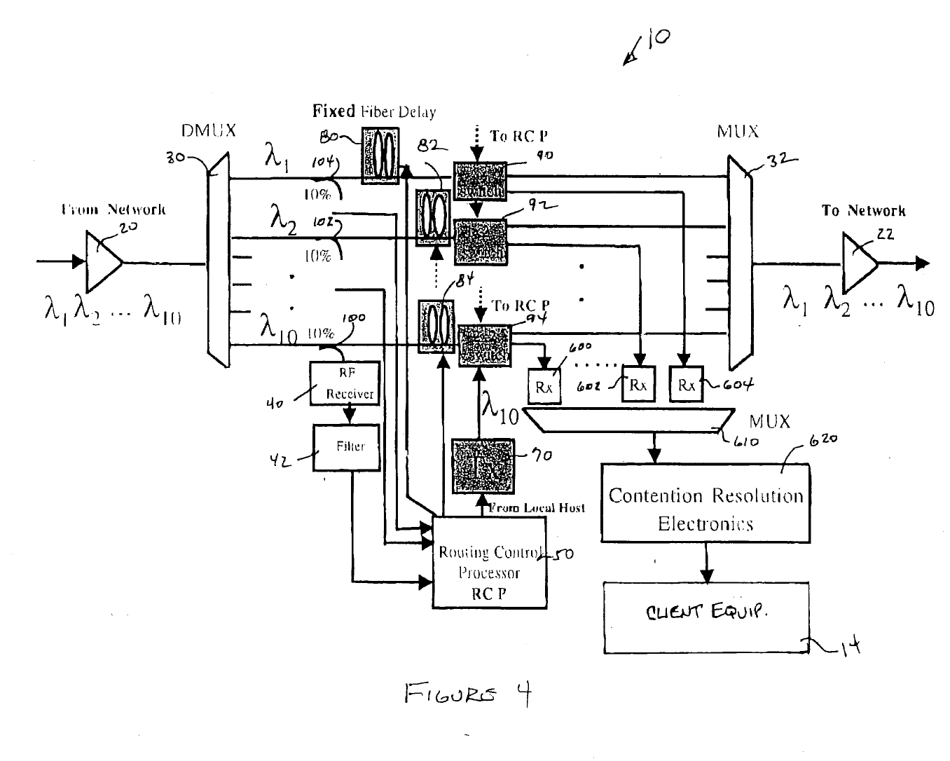

As embodied herein, and depicted in FIG. 4, a detail view of the optical network interface router 10 in accordance with a second embodiment of the present invention is disclosed. The router depicted in FIG. 4 is very similar to the router depicted in FIG. 3 with the following exceptions. In FIG. 4, fixed fiber delays replace the variable fiber delays employed in FIG. 3. Second, each burst-mode receivers (600, 602, . . . , 604) is directly coupled to a corresponding one of the outputs of switches (90, 92, . . . , 94). The burst-mode receivers are coupled to electronic multiplexer/buffer 610. Buffer 610 is coupled to contention resolution electronics 620. The embodiment depicted in FIG. 4 provides packet contention resolution in the electrical domain, rather than in the optical domain. Thus, the need for variable fiber delays is eliminated. The components used in this embodiment are similar to those used in FIG. 3.

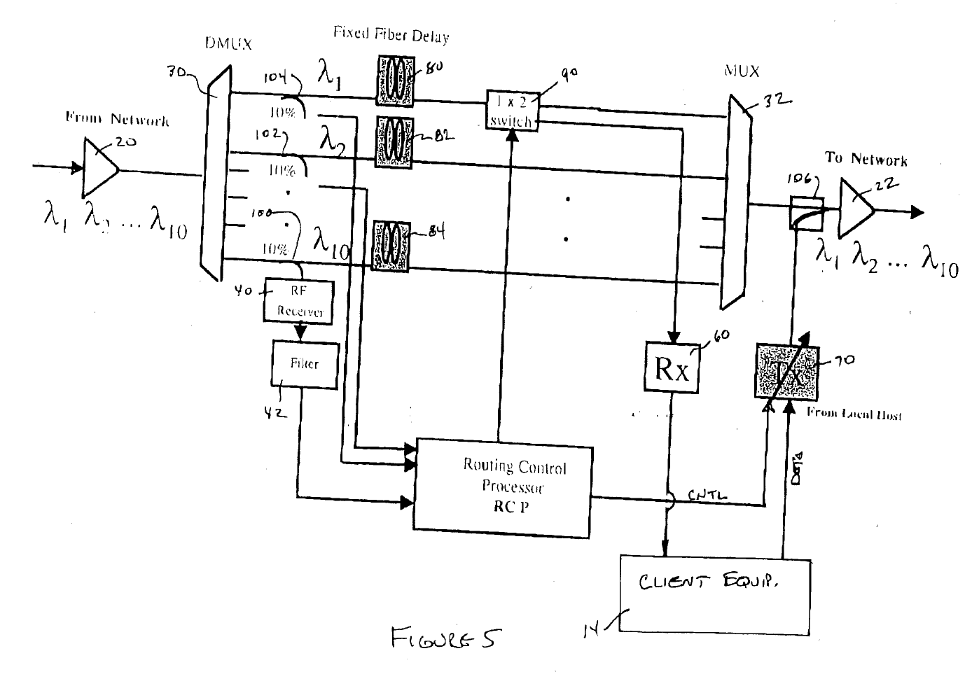

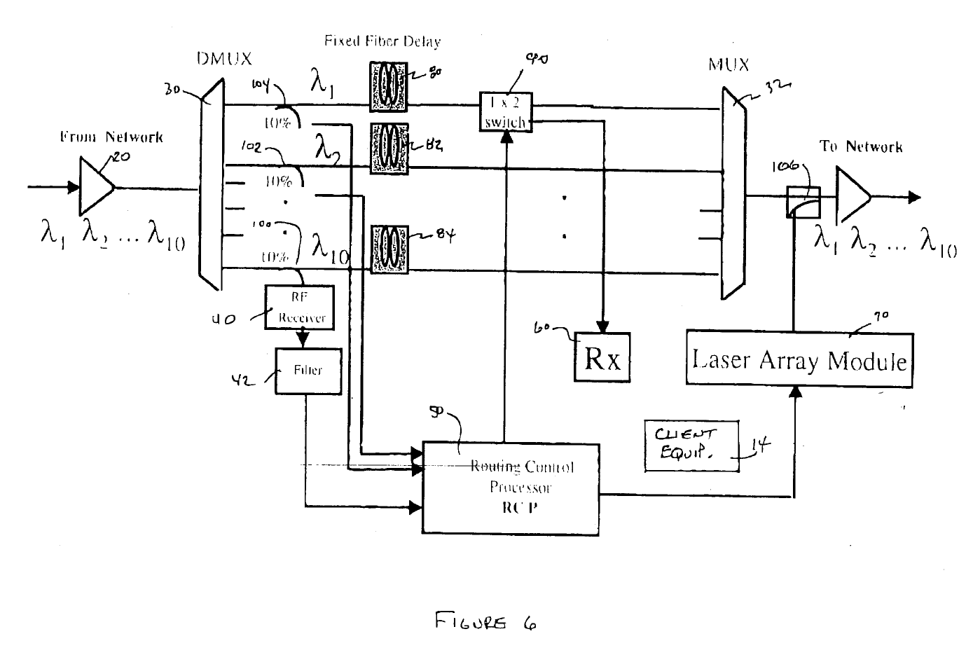

Referring to FIG. 5, a third embodiment of router 10 is disclosed. FIG. 5 represents a fixed receiver/variable transmitter approach. In FIG. 5, only one wavelength channel is fully acquired by router 10. RF receivers 40, band pass filters 42, and RCP 50 are substantially the same as the components depicted in FIG. 3 and FIG. 4. RCP 50 continues to monitor the SCM headers of all packets passing through the node for packet contention purposes. However, only the packets propagating on one wavelength channel are received. Thus, only one 1×2 optical switch 90 is coupled to receiver 60. The fixed transmitter used in the first two embodiments is replaced by a rapidly tunable transmitter 70. RCP controls the transmission time to avoid collisions with express packets passing through the node. FIG. 6 represents a slight modification of the router depicted in FIG. 5. This embodiment also represents a fixed receiver/variable transmitter approach. The transmitter 70 employed in FIG. 6 employs an array of fixed laser transmitters used in place of the rapidly tunable laser depicted in FIG. 5.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An optical router device for routing optical packets in a TDM/WDM optical network, the optical device being disposed in a node of the WDM optical network, the WDM optical network being configured to accommodate a plurality of wavelength channels, each of the plurality of wavelength channels configured to propagate optical packets in a time division multiplexed (TDM) arrangement, each optical packet including a baseband-payload and a subcarrier modulated (SCM) header, the device comprising:
an optical WDM demultiplexer configured to demultiplex the plurality of wavelength channels;
at least one header recovery component coupled to the optical WDM demultiplexer, the at least one header recovery element being configured to recover the SCM header in each optical packet propagating on each demultiplexed wavelength channel; and
a routing control processor (RCP) coupled to the at least one header recovery component, the RCP being configured to analyze the SCM header to determine which optical packets are destined for the node.

2. The device of claim 1, further comprising at least one optical receiver coupled to the RCP, the at least one receiver being configured to acquire the baseband payload in an optical packet if the optical packet is destined for the node.

3. The device of claim 2, wherein the RCP is configured to direct the optical packet to the at least one optical receiver if the optical packet is destined for the node.

4. The optical device of claim 2, further comprising:
an optical WDM multiplexer configured to multiplex the plurality of wavelength channels; and
at least one switch coupled to the RCP and the optical WDM multiplexer, the at least one switch being configured to direct the optical packet into the at least one optical receiver if the RCP determines that the optical packet is destined for the node.

5. The device of claim 4, wherein the at least one switch is configured to direct the optical packet into the optical WDM multiplexer if the RCP determines that the optical packet is not destined for the node.

6. The device of claim 2, further comprising at least one fiber delay component coupled between the optical WDM demultiplexer and the at least one optical receiver, the at least one fiber delay component delaying an optical packet's arrival at the at least one receiver by a first time period that is greater than a second time period required to analyze the optical packet's SCM header.

7. The device of claim 6, wherein the at least one fiber delay component includes a fixed fiber delay component.

8. The device of claim 6, wherein the at least one fiber delay component includes a plurality of fiber delay components, each of the plurality of fiber delay components accommodating one of the plurality of wavelength channels demultiplexed by the optical WDM demultiplexer.

9. The device of claim 8, wherein the at least one fiber delay component includes a variable fiber delay component, the variable fiber delay component being configured to resolve optical packet contention between optical packets propagating on the plurality of wavelength channels demultiplexed by the optical WDM demultiplexer.

10. The optical device of claim 2, wherein the at least one optical receiver includes a plurality of burst-mode receivers, each burst-mode receiver being coupled to one wavelength channel of the plurality of wavelength channels, each burst-mode receiver being configured to convert an optical packet's baseband-payload into an electronic data.

11. The optical device of claim 10, further comprising:
an electronic multiplexer coupled to the plurality of burst-mode receivers, the electrical multiplexer being configured to buffer the electronic data; and
contention resolution electronics coupled to the electronic multiplexer, the contention resolution electronics being configured to resolve packet contention electronically.

12. The optical device of claim 2, wherein the at least one optical receiver includes one receiver configured to receive only one wavelength channel of the plurality of wavelength channels.

13. The optical device of claim 1, further comprising at least one optical transmitter includes one transmitter configured to propagate an optical packet over one wavelength channel.

14. The optical device of claim 13, wherein the at least one optical transmitter further comprises a DFB laser coupled to a differential Mach-Zehnder modulator.

15. The optical device of claim 13, wherein the at least one optical transmitter includes a tunable transmitter configured to propagate an optical packet over the plurality of wavelength channels.

16. The optical device of claim 13, wherein the at least one optical transmitter includes a plurality of transmitters, each transmitter being configured to propagate an optical packet over one wavelength channel of the plurality of wavelength channels.

17. The optical device of claim 1, wherein the at least one header recovery component includes a plurality of header recovery components coupled to the optical WDM multiplexer, each header recovery component corresponding to one wavelength channel in the plurality of wavelength channels.

18. A method for optical packet switching in a WDM optical network, the WDM optical network including a plurality of nodes, the WDM optical network being configured to accommodate a plurality of wavelength channels, each of the plurality of wavelength channels is configured to propagate optical packets in a time division multiplexed (TDM) arrangement, the method comprising:
transmitting at least one optical packet over a predetermined wavelength channel in the WVDM optical network, the at least one optical packet including a baseband-payload and a subcarrier modulated (SCM) header;
demultiplexing the predetermined wavelength channel from the plurality of wavelength channels at a node in the WDM optical network;
detecting the SCM header in the at least one optical packet propagating over the predetermined wavelength channel;
analyzing the SCM header to determine whether the at least one optical packet is destined for the node; and
acquiring the baseband-payload if it is determined that the at least one optical packet is destined for the node.

19. The method of claim 18, wherein the at least one packet is propagating on the predetermined wavelength channel is directed through the node if it is determined that the at least one optical packet is not destined for the node.

20. The method of claim 19, wherein the predetermined wavelength channel is multiplexed into the plurality of wavelength channels before being directed out of the node.

21. The method of claim 18, further comprising the step of delaying the baseband-payload for a first time period that is greater than an elapsed time period required to analyze the optical packet's SCM header.

22. The method of claim 21, wherein the first time period is a fixed time period.

23. The method of claim 21, wherein the first time period is a variable time period.

24. The method of claim 23, wherein the variable time period is adjusted to resolve optical packet contention between optical packets propagating on the plurality of wavelength channels.

25. The method of claim 18, wherein the step of acquiring includes receiving optical packets from the plurality of wavelength channels.

26. The method of claim 18, wherein the step of acquiring includes receiving optical packets from only one of the plurality of wavelength channels.

27. The method of claim 27, wherein the step of transmitting includes transmitting optical packets over a plurality of wavelength channels.

28. An optical network for routing optical packets, the WDM optical network being configured to accommodate a plurality of wavelength channels, each of the plurality of wavelength channels propagating optical packets in a time division multiplexed (TDM) arrangement, each optical packet including a baseband-payload and a subcarrier modulated (SCM) header, the network comprising:
a plurality of nodes;
an optical layer interconnecting the plurality of nodes; and
an optical router disposed at each of the plurality of nodes, the optical router including,
an optical WDM demultiplexer configured to demultiplex the plurality of wavelength channels,
at least one header recovery component coupled to the optical WDM demultiplexer, the at least one header recovery element being configured to recover the SCM header in each optical packet propagating on each demultiplexed wavelength channel, and
a routing control processor (RCP) coupled to the at least one header recovery component, the RCP being configured to analyze the SCM header to determine whether the optical packet is destined for the node.
